(19) United States
(12) Patent Application Publication
(10) Pub. No.: US 2026/0255380 A1
(43) Pub. Date: Aug. 27, 2026

(54) SYSTEMS AND METHODS FOR PROVIDING PRIORITIZED WI-FI ACCESS

(71) Applicant: AT&T Mobility II LLC, Atlanta, GA (US)

(72) Inventor: Christopher San Gaspar, Alexandria, VA (US)

(73) Assignee: AT&T Mobility II LLC, Atlanta, GA (US)

(21) Appl. No.: 19/060,239

(22) Filed: Feb. 21, 2025

(51) Int. Cl. H04W 72/566; H04W 4/06; H04W 4/90; H04W 16/14

(52) U.S. Cl. CPC H04W 72/566; H04W 4/06; H04W 4/90; H04W 16/14

(57) ABSTRACT

Aspects of the subject disclosure may include, for example, providing prioritized Wi-Fi access to public service user equipment for use by government users and emergency service providers. The prioritized Wi-Fi access may include allocating dedicated Wi-Fi channels or enhancing Quality of Service (QoS), for example, during network congestion. The public service user equipment send, to an Wi-Fi access point, a priority access request with a Emergency Preparedness Communication Service (EPCS) indicator for verifying eligibility of the prioritized Wi-Fi access at a Wi-Fi backend network. Other embodiments are disclosed.

### FIELD OF THE DISCLOSURE

The subject disclosure relates to systems and methods for providing prioritized Wi-Fi access to public service user equipment.

### BACKGROUND

Currently, any traffic that goes to public Wi-Fi are treated with quality of service corresponding to best efforts. Both commercial (e.g. for private use) and government traffic (e.g., for public use), when connected to Wi-Fi, may be equally treated, such as on a first come, first serve basis in the public Wi-Fi setting. When the public Wi-Fi network is congested, public users such as government users are unable to connect to their mission critical data, voice and video traffic. Wireless providers provide best effort quality of service, regardless of whether user equipment request services required for public services or not. In cellular communication networks, a certain frequency spectrum has been dedicated to public safety and government use. However, Wi-Fi network providers may not have a mechanism to prioritize certain type of users or services in the Wi-Fi network, especially during network congestion.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts example, non-limiting operations of a system for providing prioritized Wi-Fi services in accordance with various aspects described herein.

FIG. 2C depicts an illustrative embodiment of a method in accordance with various aspects described herein.

FIG. 2D depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods for providing prioritized Wi-Fi access to public service user equipment. For instance, the prioritized Wi-Fi access can be provided by allocating a dedicated Wi-Fi channel on one or more wireless access points. As another example, the prioritized Wi-Fi access can be provided by allocating a higher level of quality of service than a best effort level to public service user equipment. The systems and methods provide a Wi-Fi frequency spectrum slice to a certain group of users, for example, government users using public service user equipment. Public service user equipment may be identified using a special indicator that is detected by wireless access points and authenticated at a backend system of a Wi-Fi service provider. Upon authentication, public service user equipment may be provided with prioritized services to the Internet. Other embodiments are described in the subject disclosure.

One or more aspects of the subject disclosure are directed to a system comprising a processing system including a processor, and a memory that stores executable instructions that, when executed by the processing system, facilitate performance of operations. The operations include broadcasting a Wi-Fi signal including an emergency priority service broadcast in a selected Wi-Fi network; receiving, from a Wi-Fi enabled user equipment (UE), a connection request including a priority access request; forwarding the connection request to a wireless controller in a Wi-Fi backend network; upon a verification of eligibility of the Wi-Fi enabled UE, receiving a connection acknowledgement for the priority access request from the wireless controller; and granting priority services to the Wi-Fi enabled UE.

One or more aspects of the subject disclosure are directed to a non-transitory machine-readable medium, comprising executable instructions that, when executed by a processing system including a processor, facilitate performance of operations. The operations include receiving a connection request from a Wi-Fi access point, the connection request including a priority access request from Wi-Fi enabled user equipment (UE), where the priority access request from the Wi-Fi enabled UE comprises a special Emergency Preparedness Communication Service (EPCS) indicator attached to the priority access request; receiving a verification of eligibility for the priority access request by the Wi-Fi enabled user equipment; authorizing the priority access request for the Wi-Fi enabled UE upon the receiving of the verification of eligibility; and communicating the authorization to the Wi-Fi access point to grant enhanced Quality of Service (QoS) to the Wi-Fi enabled UE.

One or more aspects of the subject disclosure are directed to a method including broadcasting, by a processing system including a processor, Wi-Fi signals including Emergency Preparedness Communication Service (EPCS) features in a selected Wi-Fi network; receiving, by the processing system, from a first user device, a request to join the selected Wi-Fi network, wherein the request to join comprises a first priority access request corresponding to the EPCS features; sending, by the processing system, a request to check a credential of the first user device to a wireless controller in a Wi-Fi backend network; receiving, by the processing system, a confirmation acknowledgement for the first priority access request; and assigning, by the processing system, a dedicated spectrum channel for data traffic of the first user device.

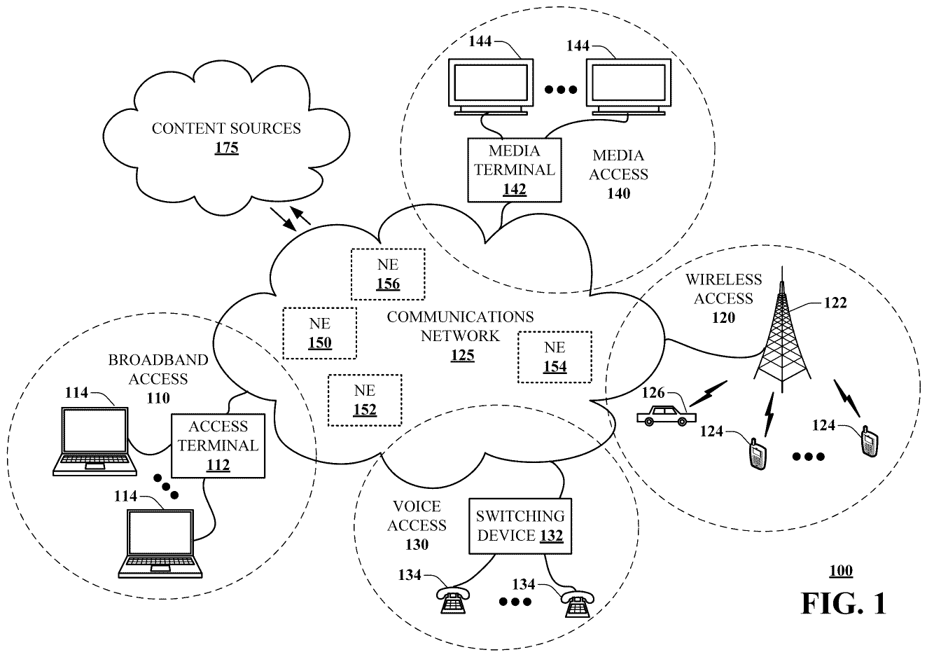

Referring now to FIG. 1, a block diagram is shown illustrating an example, non-limiting embodiment of a system 100 in accordance with various aspects described herein. For example, system 100 can facilitate in whole or in part systems and methods for providing prioritized Wi-Fi access to public service user equipment. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

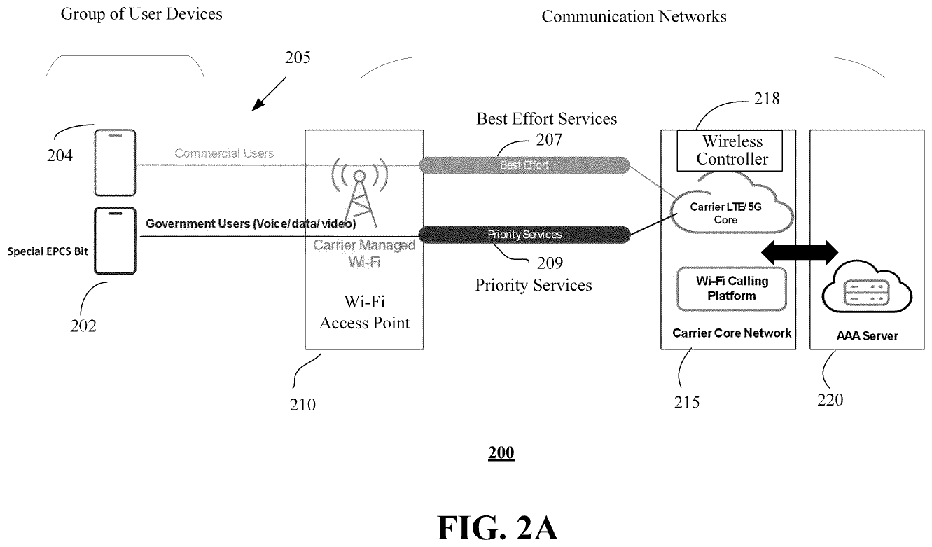

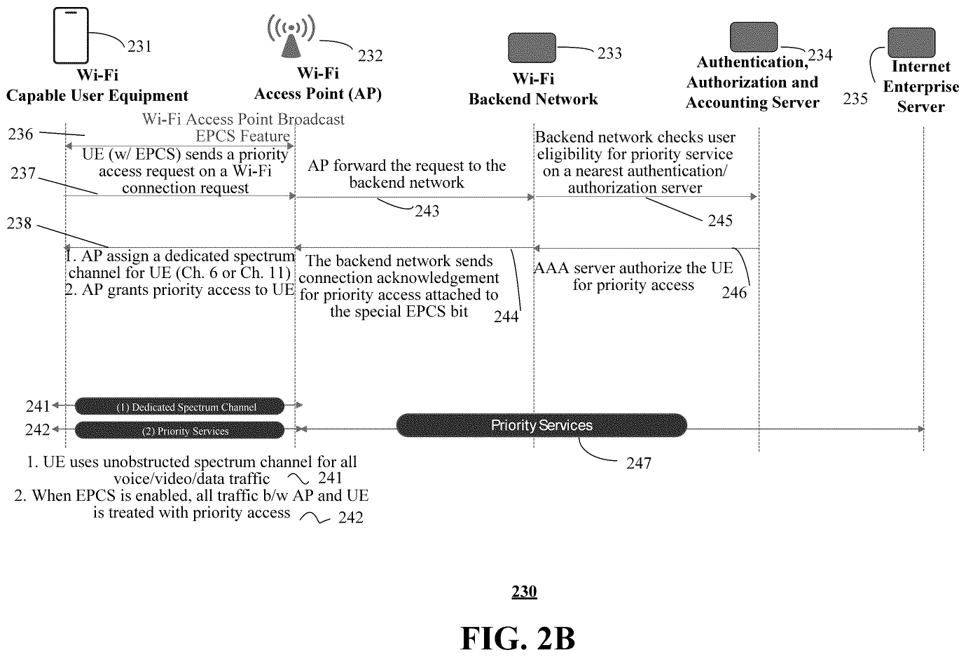

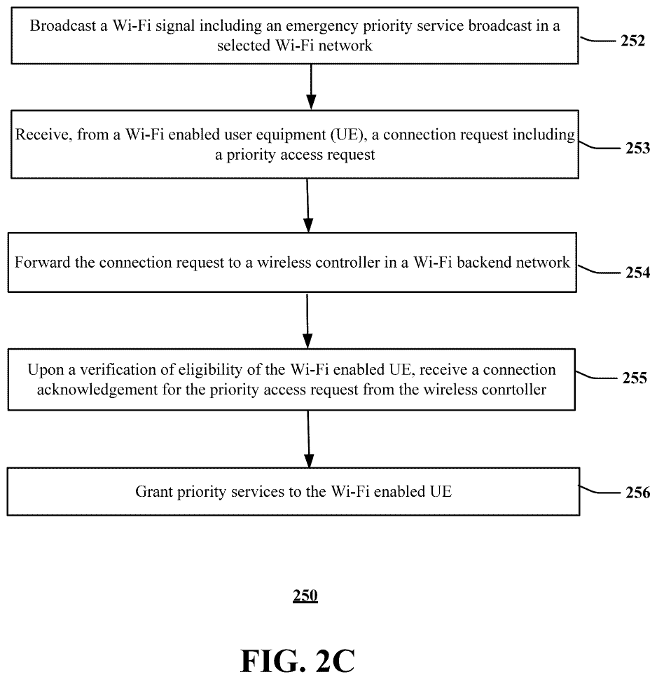

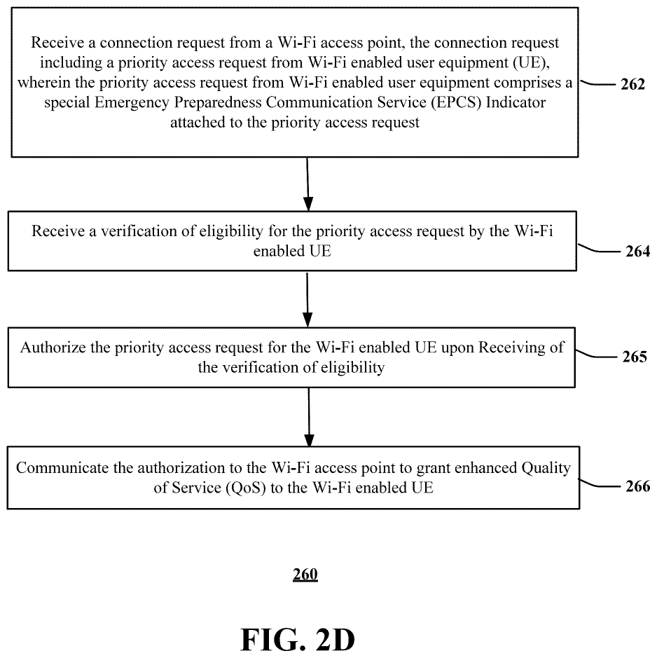

FIG. 2A is a block diagram illustrating an example, non-limiting embodiment of a system 200 functioning within the communication network of FIG. 1 in accordance with various aspects described herein. In one or more embodiments, the system 200 may dedicate certain Wi-Fi channels (2.4 Ghz, 5 Ghz, etc.) on a Wi-Fi access point 210 for providing priority access services for public users such as government users. Public users include various government users, first responders, emergency crews, firefighters, etc. and engage in public services to serve the general public as opposed to private user services, commercial services, etc. Mobile communication networks (e.g., cellular networks) have provided prioritized and/or dedicated services to such public users in various ways to accommodate urgent and public nature of services. User equipment used by public users for performing their missions or tasks are referred to as public service user equipment.

Currently, any traffic that goes to Wi-Fi are best efforts as a default. Both private/commercial traffic and public/government traffic, upon connection to Wi-Fi, are equally treated and subject to the same quality of services. For instance, while the Wi-Fi is congested, public users such as government users may be unable to connect to their mission critical data, voice and video traffic, waiting in queue which is moving on a first come first basis. Wireless providers provide best effort services, regardless of whether requests are coming from public service user equipment or a commercial or private user. Wireless providers do not have a mechanism to prioritize certain type of users in the Wi-Fi network especially during network congestion.

In various embodiments, the system 200 may enable wireless service providers to provide a higher level of Quality of Service (QoS) and/or priority services for certain type of users such as public users such as a government user and secondary users that provide support for government. By dedicating certain spectrum channels on the Wi-Fi access points, public service users such as government users can effectively access their mission critical traffic when connected to Wi-Fi, including network congestion times. Public service user equipment will be able to use these dedicated channels while using Wi-Fi networks, thereby allowing them to avoid interruption by other non-priority traffic and non-priority users. Public user traffic can be prioritized against other non-priority users traffic on the Wi-Fi network.

In FIG. 2A, user devices include two different groups, such as government users, commercial/private users. By way of example, the government users include Department of Homeland Security (DHS) users (voice/data/video), emergency responder users (voice/data/video), etc. User devices 202, 204 can be any device equipped with a Wi-Fi transceiver, such as a smartphone, tablet, laptop, or desktop computer. The Wi-Fi access point (AP) 210 provides wireless connectivity to the user devices 202, 204. The Wi-Fi AP 210 can be a standalone device or integrated into a router. In FIG. 2A, the Wi-Fi AP 210 is depicted for convenience of description and the present disclosure is not limited thereto and includes multiple access points at different locations.

The user devices 202 and 204 are connected to the Internet via Wi-Fi. The Wi-Fi AP 210 broadcasts a wireless signal over a specific frequency band (e.g., 2.4 GHz or 5 GHz). This signal contains a network's Service Set Identifier (SSID), which is the name of a Wi-Fi network 205. The user devices 202 and 204 scan for available Wi-Fi networks within range as the Wi-Fi AP 210 broadcasts Wi-Fi networks along with other access points. Wi-Fi networks may include public Wi-Fi networks and the user devices 202 and 204 have access thereto. The user devices 202, 204 detect the SSID broadcast by the AP 210 and other access points and displays a list of available networks on user interfaces of the user devices 202, 204. The user devices 202 and 204 select the Wi-Fi network 205 from the list. The user devices 202 and 204 send a request to the AP 210 to join the Wi-Fi network 205. If authentication credentials may not be required (e.g., public Wi-Fi), the AP 210 allows the user devices 202, 204 to join the Wi-Fi network 205. Once joined, the user devices 202 and 204 need an IP address to communicate on the Wi-Fi network 205. The router (not shown) typically uses the Dynamic Host Configuration Protocol (DHCP) to assign an IP address to the user devices 202, 204. The user devices 202, 204 send a DHCP request, and the router responds with an available IP address. The user devices 202 and 204 configure its network settings based on the information received from the DHCP server, including the IP address, a subnet mask, a default gateway, and DNS server addresses.

With the network configuration complete, the user devices 202, 204 can now send and receive data over the Wi-Fi network 205. Data packets are transmitted wirelessly between the user devices 202, 204 and the AP 210. The AP 210 forwards the data packets to the router (not shown). The router determines the best path for the data to reach its destination on the internet. It sends the data to a modem (not shown), which modulates the signals for transmission over the ISP's infrastructure. The Internet Service Provider (ISP) routes the data to its final destination on the internet, such as a web server, via a carrier core network 215. The web server at the final destination processes the request and sends the response back through the ISP, the modem, the router, and the AP 210 to the user devices 202, 204. This process of data transmission and routing continues as long as the user devices 202, 204 remain connected to the Wi-Fi network, allowing the user to browse the internet, stream media, and perform other online activities.

As depicted in FIG. 2A, the user devices 202 and 204 are equipped with wireless transceivers that allow them to communicate over various frequency bands, including the 2.4 GHz and 5 GHz bands commonly used in Wi-Fi networks. The 2.4 GHz band is one of the most widely used frequency bands for Wi-Fi communication. The 2.4 GHz offers several advantages. The 2.4 GHz band provides a longer range compared to the 5 GHz band. This is because lower frequency signals can travel further and penetrate obstacles like walls more effectively. Most Wi-Fi devices support the 2.4 GHz band, making it highly compatible with a wide range of user equipment. However, the 2.4 GHz band is also more prone to interference from other devices such as microwaves, cordless phones, and Bluetooth devices, which operate in the same frequency range.

The 5 GHz band is another frequency band used for Wi-Fi communication, offering different advantages. The 5 GHz band can support higher data rates compared to the 2.4 GHz band. This is because it has more available channels and less interference, allowing for faster data transmission. The 5 GHz band experiences less interference from other devices, as fewer non-Wi-Fi devices operate in this frequency range. The 5 GHz band has a shorter range compared to the 2.4 GHz band. Higher frequency signals have more difficulty penetrating obstacles, which can limit their effective range.

Many user equipment devices are equipped with dual-band or tri-band capabilities, allowing them to operate on both the 2.4 GHz and 5 GHz bands, and sometimes even a third band. Dual-band and tri-band devices can switch between bands to optimize performance based on the current network conditions. For example, a device might use the 2.4 GHz band for better range when far from the access point and switch to the 5 GHz band for higher speeds when closer. These devices can help balance the load on the network by distributing devices across different frequency bands, reducing congestion and improving overall network performance. Supporting multiple bands ensures that the device remains compatible with future network upgrades and changes in Wi-Fi technology.

In addition to the widely used 2.4 GHz and 5 GHz bands, there are other frequency bands available for Wi-Fi communication. These bands offer various advantages and are increasingly being utilized to meet the growing demand for wireless connectivity. For instance, the 6 GHz band is a relatively new addition to the Wi-Fi spectrum, introduced with Wi-Fi 6E (802.11 ax). It offers several benefits. The 6 GHz band provides a significant increase in available spectrum, offering up to 1,200 MHz of additional bandwidth. This helps alleviate congestion in the 2.4 GHz and 5 GHz bands.

With more channels and wider channel bandwidths (up to 160 MHz), the 6 GHz band supports higher data rates and improved performance. The 6 GHz band is less crowded than the 2.4 GHz and 5 GHz bands, resulting in reduced interference and better overall network performance.

As another example, the 60 GHz band, also known as WiGig (802.11ad and 802.11ay), is used for ultra-high-speed wireless communication over short distances. The 60 GHz band supports extremely high data rates, up to several gigabits per second, making it ideal for applications requiring large data transfers, such as wireless docking stations and virtual reality. Due to the high frequency, the 60 GHz band has a limited range and is best suited for line-of-sight communication within a single room or small area. The 60 GHz band experiences minimal interference from other devices, as it is less commonly used and has a high absorption rate by obstacles like walls.

Sub-1 GHz frequency bands, such as the 900 MHz band, may also be used for Wi-Fi communication in certain regions. Sub-1 GHz bands provide longer range and better penetration through obstacles compared to higher frequency bands, making them suitable for rural and remote areas. Devices operating in sub-1 GHz bands typically consume less power, which is beneficial for battery-operated devices and Internet of Things (IoT) applications. The available bandwidth in sub-1 GHz bands is limited, resulting in lower data rates compared to higher frequency bands.

The 3.5 GHz band, also known as the Citizens Broadband Radio Service (CBRS) band in the United States, is another frequency band available for Wi-Fi and other wireless communication. The 3.5 GHz band operates under a shared spectrum model, allowing multiple users to access the band while ensuring interference protection for incumbent users. The 3.5 GHz band offers a balance between range and data rates, providing better performance than sub-1 GHz bands while offering greater coverage than higher frequency bands. The 3.5 GHz band is well-suited for private LTE and 5G networks, enabling enterprises to deploy their own wireless networks with enhanced control and security.

In addition to the 2.4 GHz and 5 GHz bands, other frequency bands such as 6 GHz, 60 GHz, sub- 1 GHz, and 3.5 GHz are available for Wi-Fi communication. Each of these bands offers unique advantages, catering to different use cases and requirements. The availability of multiple frequency bands helps address the growing demand for wireless connectivity, providing users with enhanced performance, capacity, and flexibility.

In various embodiments, the Wi-Fi network 205 is configured such that the access point 210 facilitates dedicated Wi-Fi channel(s) for a specific user such as government users. The dedicated Wi-Fi channels facilitate and implement different quality of services (QoS) in a transport layer across a core backbone network by a Wi-Fi service provider. As depicted in FIG. 2A, commercial/private users 204 will be provided with best effort services 207, whereas government users using public service user equipment will be provided with priority services 209, respectively. In other embodiments, the priority services 209 can be differentiated depending on a specific user group of public users, by way of example only a first priority service level for DHS user equipment, a second priority service level for the emergency crew user equipment, etc., in order to accommodate different circumstances, urgency of needs, etc. In further another embodiment, the priority services 209 may be made available to commercial users for emergency situations, based on priority subscription, etc.

In one or more embodiments, the public service user equipment such as the user device 202 may provide emergency preparedness communication services (EPCS). Wi-Fi 7 (also known as IEEE 802.11be), is the next generation of Wi-Fi technology and one of the key features of Wi-Fi 7 is its ability to support Emergency Preparedness Communication Services (EPCS), which are designed to provide robust and reliable communication channels during emergencies and critical situations. Key Features of Wi-Fi 7 EPCS include high throughput and low latency (potentially exceeding 30 Gbps), multi-link operation (simultaneously transmit and receive data across multiple frequency bands (e.g., 2.4 GHz, 5 GHz, and 6 GHz)), enhanced quality of service, improved spectrum efficiency, increased channel widths (up to 320 MHz), etc. Wi-Fi 7 EPCS may be used for disaster response, public safety events, critical infrastructure monitoring, healthcare emergencies. The EPCS feature has been proposed by Department of Homeland Security (DHS) as an optional feature to selected to be implemented by access point providers.

Referring back to FIG. 2A, the user device 202, as public service user equipment, may include a special EPCS indicator such as an EPCS bit which enables the AP 210 to identify the user device 202 as the public service user equipment and distinguish from the private or commercial user equipment (e.g., the user device 204). In some embodiments, a physical layer frame structure of Wi-Fi includes data, control information, and management information as they are transmitted over the air. For instance, the physical layer frame structure of Wi-Fi includes a preamble, a header, and payload. The preamble is used for synchronization, allowing a receiver to establish the timing of incoming signals. The header contains control information, such as a data transmission rate, the length of payload, etc. The payload carries actual data being transmitted. In some embodiments, the special EPCS bit may be included in the header. In other embodiments, the special EPCS bit may be included in the payload.

In other embodiments, the public service user equipment such as the user device 202 includes different EPCS bits which may differentiate types of public service user equipment in order to provide different levels of quality of service requirements. In further another embodiment, private user equipment may include an identification bit that indicates subscription tailored to a higher level of quality of service requirements for emergency situations, etc.

The system 200 includes a carrier core network 215 and an authentication, authorization, and accounting (AAA) server 220. The carrier core network 215 includes a carrier LTE/5G core network and a Wi-Fi calling platform. The carrier core network 215 transmits and receives the Wi-Fi network traffic to/from the Internet. The carrier core network 215 further includes a wireless controller 218 in communication with multiple access points including the AP 210 and managing all of the access points in the Wi-Fi network 205, connecting the access points to the internet. The wireless controller 218 is in communication with the AAA server 220 in order to authorize user devices to access a particular service. The AAA server 220 is configured to ensure secure access to network resources, managing user permissions, and tracking user activities. The AAA server 220 is operable to authenticate users by checking credentials provided by users against a database of authorized users, using digital certificates, etc. The AAA server 220 further determines what resources and services an authenticated user or device is allowed to access. The AAA server 220 tracks and records user activities on the network by using session logging, usage monitoring (e.g., the amount of data transmitted and received by users) for billing purposes, etc.

In connection with the Wi-Fi networks including the Wi-Fi network 205, the AAA server 220 authenticates users and devices attempting to connect to the Wi-Fi network, ensuring that only authorized entities gain access. The AAA server 220 can enforce QoS policies, prioritizing traffic for certain users or applications, such as emergency responders or certain communication services.

As depicted in FIG. 2A, the AP 210 communicates with the wireless controller 218 to check if a particular UE device (e.g., the user device 202) is authorized to access prioritized services. The wireless controller 218 will communicate with the AAA server 220 to inquire whether the user device 202 is capable of and eligible for receiving prioritized services. In one or more embodiments, the AAA server 220 is in communication with government agencies and obtains information identifying that the user device 202 is in fact public service user equipment. For instance, the AAA server 220 is configured to check the user device 202 against the identification information of the public service user equipment stored in a database thereof and determine whether the user device 202 is the public server user equipment. Then the AAA server 220 will pass the authorization to the wireless controller 218 which will in turn pass to the AP 210.

In one or more embodiments, the AP 210 may collect data relating to Wi-Fi network congestion, load, performance, etc. and report the data to the wireless controller 218. Based on the data received from the AP 210, the wireless controller 218 manages network resources and connections among multiple access points and user devices. In some embodiments, the AP 210 may include logics that monitor load and performance of the Wi-Fi network and make determinations as to prioritized services to different user equipment in conjunction with the wireless controller 218.

FIG. 2B depicts example, non-limiting operations of a system 230 for providing prioritized Wi-Fi services in accordance with various aspects described herein. The system 230 is configured to provide prioritized Wi-Fi services to a particular group of user equipment such as public service user equipment (UE). The system 230 includes Wi-Fi capable device 231 as the public service UE. The Wi-Fi capable device 231 is connected to a Wi-Fi access point 232, which communicates with a Wi-Fi backend network 233. The Wi-Fi backend network 233 communicates with an authentication, authorization and accounting (AAA) server 234. The Wi-Fi access point 232 is in communication with an internet enterprise server 235.

In one or more embodiments, the Wi-Fi access point 232 broadcasts Emergency Prepared Communication Service (EPCS) feature (Act 236). The Wi-Fi capable device 231 is equipped with EPCS capabilities or features and detects the broadcast. The Wi-Fi capable device 231 corresponds to public service UE and is equipped with the EPCS capabilities or features. For instance, the Wi-Fi capable device 231 includes a special EPCS bit. The Wi-Fi capable device 231 sends a priority access request on a Wi-Fi connection request (Act 237). The Wi-Fi access point 232 forwards the Wi-Fi connection request including the special EPCS bit to the backend network 233 (Act 243). The backend network 233 checks user eligibility for priority service on a nearest authentication, authorization and accounting (AAA) server 234 (Act 245). The AAA 234 server authorizes the Wi-Fi capable device 231 for priority access (Act 246). The backend network 233 sends connection acknowledgement for the priority access attached to the special EPCS bit (Act 244).

In one or more embodiments, the Wi-Fi AP 232 assigns a dedicated spectrum channel for the Wi-Fi capable device 231. For instance, the dedicated spectrum includes channel 6 or channel 11 (Act 238). The dedicated spectrum may allow public service user equipment to have access to better services as commercial or private user devices are not allowed to use the dedicated spectrum. The dedicated spectrum, once granted, enables Wi-Fi capable user devices to use an unobstructed spectrum channel for all voice, video and data traffic (Act 241). Additionally or alternatively, the Wi-Fi AP 232 grants priority services to the UE (Act 238). When EPCS is enabled, all traffic between the Wi-Fi AP 232 and the Wi-Fi capable devices is treated with the priority services (Act 242). The priority services 247 are established, activated and made available between the Wi-Fi AP 232 and the internet enterprise server 235. The priority services 247 may allow the public service UE to have access to prioritized services over private user equipment which have been already in queue. The Wi-Fi AP 232 may manage a request from the public service UE to be transmitted with priority over requests from commercial or private user devices.

FIG. 2C depicts an illustrative embodiment of a method 250 in accordance with various aspects described herein. In one or more embodiments, the method 250 includes broadcasting a Wi-Fi signal that incorporates an emergency priority service broadcast to alert user equipment of available priority services in a selected Wi-Fi network (Step 252). The method 250 then includes receiving a connection request from Wi-Fi enabled user equipment, which includes a priority access request indicating the need for prioritized services (Step 253). The method 250 proceeds by forwarding the connection request to a wireless controller within a backend network to facilitate further processing and verification (Step 254). Upon successful verification, the method 250 includes receiving a connection acknowledgment that confirms the authorization of priority access for the user equipment from the wireless controller (Step 255). The method 250 grants priority access to the Wi-Fi enabled user equipment, ensuring enhanced Quality of Service (QoS) for the authorized device (Step 256).

In one or more embodiments, the method 250 further includes receiving a special Emergency Preparedness Communication Services (EPCS) indicator included in the priority access request. This special EPCS indicator identifies the Wi-Fi enabled user equipment as public service user equipment eligible for priority services. Upon granting priority services, the method 250 can assign a dedicated spectrum channel to the Wi-Fi enabled user equipment. This dedicated spectrum channel may include frequencies such as Wi-Fi channel 6 or channel 11. The method 250 prioritizes data traffic between the Wi-Fi enabled user equipment and the Internet over data traffic from other user equipment connected to the selected Wi-Fi network. Additionally, the method 250 sets a quality of service level for data traffic from a first user equipment lacking the special EPCS indicator as a best effort level, while setting a higher prioritized level for a second user equipment providing the special EPCS indicator. The method 250 also collects data relating to the performance and load of the selected Wi-Fi network and transmits this collected data to the wireless controller in the Wi-Fi backend network. This method 250 ensures that public service user equipment receives prioritized and enhanced quality of services.

FIG. 2D depicts an illustrative embodiment of a method in accordance with various aspects described herein. In one or more embodiments, the method 260 includes receiving a connection request from a Wi-Fi access point, where the request includes a priority access request from Wi-Fi enabled user equipment, and the priority access request comprises a special Emergency Preparedness Communication Service (EPCS) bit (Step 262). The method 260 further includes receiving verification of eligibility for the priority access request by the Wi-Fi enabled user equipment (Step 264). The method 260 then authorizes the priority access for the Wi-Fi enabled user equipment upon successful verification (Step 265). Finally, the method 260 communicates the authorization to the Wi-Fi access point to enable the granting of enhanced Quality of Service (QoS) to the authorized user equipment (Step 266).

In one or more embodiments, the method 260 further includes communicating with an Authentication, Authorization, and Accounting (AAA) server to verify the priority access request against a database of authorized public service user equipment. The method 260 also involves receiving confirmation from the AAA server regarding the eligibility of the Wi-Fi enabled user equipment for priority access before authorizing the priority access. The AAA server obtains authorized public service user equipment information in communication with a government system that identifies the authorized public service user equipment. The method 260 further includes transmitting connection acknowledgement for the priority access request. Moreover, the method 260 monitors network congestion and load data received from the Wi-Fi access point to optimize resource allocation and maintain service quality for authorized user equipment.

While for purposes of simplicity of explanation, the respective processes are shown and described as a series of blocks in FIGS. 2C and 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, a method involves broadcasting Wi-Fi signals that include Emergency Preparedness Communication Service (EPCS) features within a selected Wi-Fi network. The method also includes receiving a request from a first user device to join the network, where the request contains a priority access request related to the EPCS features. In some embodiments, a special EPCS indicator is attached to the first priority access request. The method sends a request to check the credentials of the first user device to a wireless controller in a Wi-Fi backend network, receives a confirmation acknowledgment for the priority access request, and assigns a dedicated spectrum channel for the data traffic of the first user device, such as assigning a Wi-Fi frequency spectrum slice for the data traffic of the first user device.

Additionally, the method includes receiving a request from a second user device to join the selected Wi-Fi network, where the request also contains a priority access request related to the EPCS features. The method involves receiving a confirmation acknowledgment for the second priority access request and providing a higher quality of service to the data traffic from the second user device compared to a best effort service. The first and second user devices correspond to public service user equipment used by government users, and in some cases, the data traffic of the first user device may be prioritized over the data traffic of the second user device. The method further involves receiving a request from a third user device to join the Wi-Fi network, where the request contains a priority access request related to the EPCS features. The method, however, includes not receiving a confirmation acknowledgment for the third priority access request and in that case, providing a best effort quality of service to the data traffic of the third user device.

In the above-described embodiments, wireless equipment providers and wireless access providers and public users such as state, local and federal government users can be benefited by dedicated Wi-Fi channels (e.g., a dedicated Wi-Fi frequency spectrum slice) provided. Wireless equipment can introduce the EPCS feature supported on wireless equipment, allowing them to coordinate with wireless access providers. Wireless access providers in turn can monetize dedicated channels in supplying priority services for government. The systems and methods in the above-described embodiments may enhance Emergency Preparedness Communication Services (EPCS).

Government agencies may provide fundings for wireless providers in support of their mission to ensure priority services on government traffic in times of disasters and events, especially when different networks are congested. Different wireless service providers provide a higher level of QoS and priority services for public users, such as state, local and federal government agencies. Different wireless service providers may monetize priority services for government traffic using the Wi-Fi network.

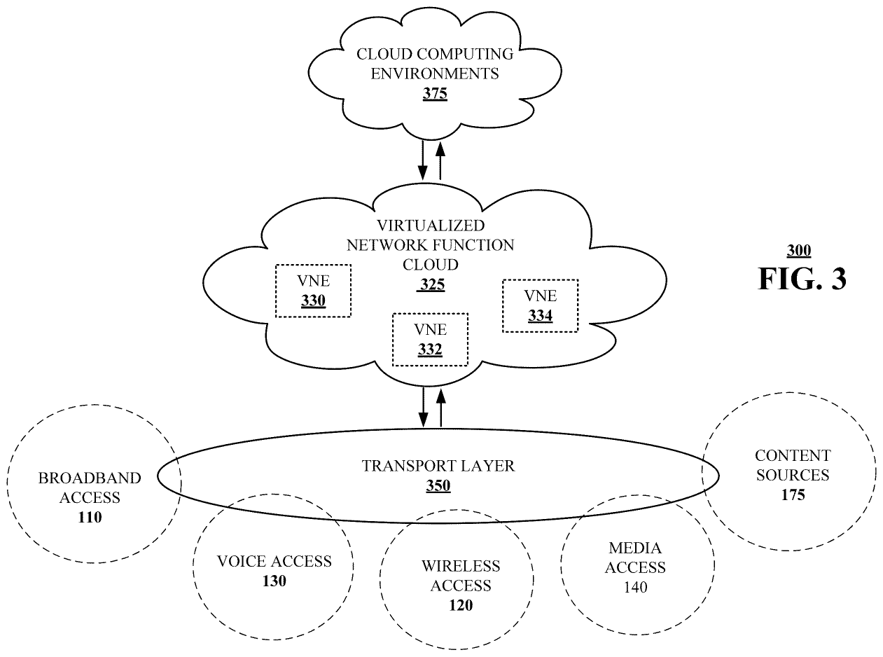

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part systems and methods for providing prioritized Wi-Fi access to public service user equipment.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

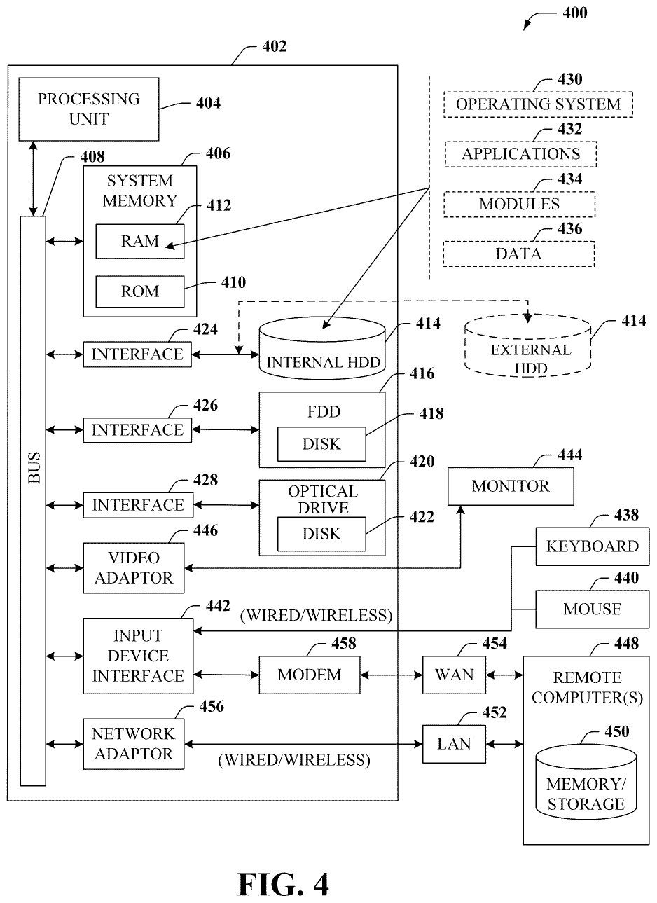

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods for providing prioritized Wi-Fi access to public service user equipment.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

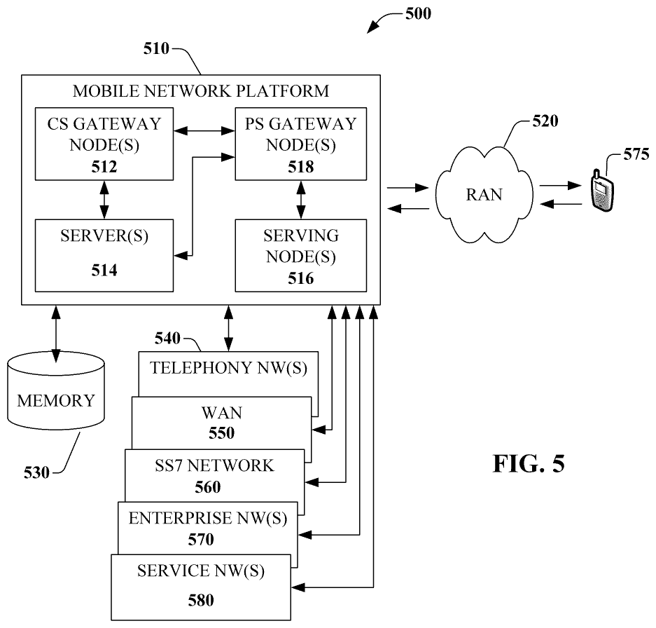

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods for providing prioritized Wi-Fi access to public service user equipment. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

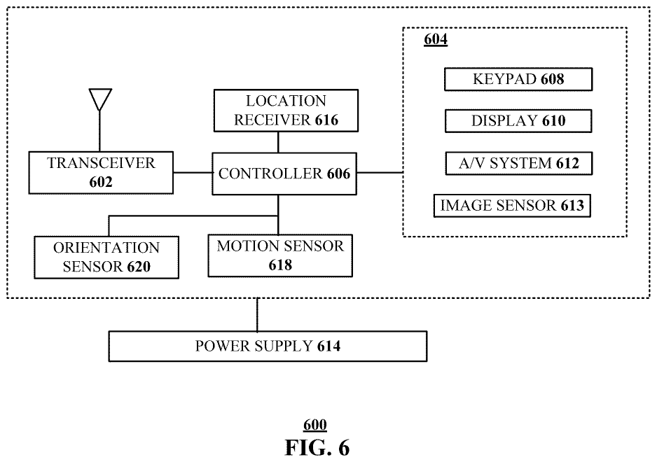

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods for providing prioritized Wi-Fi access to public service user equipment.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a processing system including a processor; and
a memory that stores executable instructions that, when executed by the processing system, facilitate performance of operations, the operations comprising:
broadcasting a Wi-Fi signal including an emergency priority service broadcast in a selected Wi-Fi network;
receiving, from a Wi-Fi enabled user equipment (UE), a connection request including a priority access request;
forwarding the connection request to a wireless controller in a Wi-Fi backend network;
upon a verification of eligibility of the Wi-Fi enabled UE, receiving a connection acknowledgement for the priority access request from the wireless controller; and
granting priority services to the Wi-Fi enabled UE.

2. The system of claim 1, wherein the operations further comprise, in response to the emergency priority service broadcast, receiving a special Emergency Preparedness Communication Services (EPCS) indicator included in the priority access request.

3. The system of claim 2, wherein the special EPCS indicator identifies the Wi-Fi enabled UE as public service user equipment that is eligible for the priority services.

4. The system of claim 1, wherein the operations further comprise, upon the granting of the priority services, assigning a dedicated spectrum channel to the Wi-Fi enabled UE.

5. The system of claim 4, wherein the dedicated spectrum channel includes a frequency of Wi-Fi channel 6 or a frequency of Wi-Fi channel 11.

6. The system of claim 1, wherein the operations further comprise, upon the granting of the priority services, prioritizing data traffic between the Wi-Fi enabled UE and Internet over data traffic from other UE connected to the selected Wi-Fi network.

7. The system of claim 3, wherein the operations further comprise:
setting a quality of service level for data traffic from a first UE lacking the special EPCS indicator as a best effort level; and
setting a quality of service level for data traffic from a second UE providing the special EPCS indicator as a prioritized level higher than the best effort level.

8. The system of claim 1, wherein the operations further comprise:
collecting data relating to performance and load of the selected Wi-Fi network; and
transmitting the collected data to the wireless controller in the Wi-Fi backend network.

9. A non-transitory machine-readable medium, comprising executable instructions that, when executed by a processing system including a processor, facilitate performance of operations, the operations comprising:
receiving a connection request from a Wi-Fi access point, the connection request including a priority access request from Wi-Fi enabled user equipment (UE), wherein the priority access request from the Wi-Fi enabled UE comprises a special Emergency Preparedness Communication Service (EPCS) indicator attached to the priority access request;
receiving a verification of eligibility for the priority access request by the Wi-Fi enabled user equipment;
authorizing the priority access request for the Wi-Fi enabled UE upon the receiving of the verification of eligibility; and
communicating the authorization to the Wi-Fi access point to grant enhanced Quality of Service (QoS) to the Wi-Fi enabled UE.

10. The non-transitory machine-readable medium of claim 9, wherein the operations further comprise communicating with an Authentication, Authorization, and Accounting (AAA) server to verify the eligibility for the priority access request of the Wi-Fi enabled UE.

11. The non-transitory machine-readable medium of claim 10, wherein the verification of eligibility for the priority access request is checked against a database of authorized public service user equipment in the AAA server.

12. The non-transitory machine-readable medium of claim 11, wherein authorized public service user equipment information is obtained by the AAA server in communication with a government system that identifies the authorized public service user equipment.

13. The non-transitory machine-readable medium of claim 9, wherein the operations further comprise transmitting connection acknowledgement for the priority access request.

14. The non-transitory machine-readable medium of claim 9, wherein the operations further comprise monitoring network congestion and load data received from the Wi-Fi access point to optimize resource allocation for the priority access request.

15. A method, comprising:
broadcasting, by a processing system including a processor, Wi-Fi signals including Emergency Preparedness Communication Service (EPCS) features in a selected Wi-Fi network;
receiving, by the processing system, from a first user device, a request to join the selected Wi-Fi network, wherein the request to join comprises a first priority access request corresponding to the EPCS features;
sending, by the processing system, a request to check a credential of the first user device to a wireless controller in a Wi-Fi backend network;
receiving, by the processing system, a confirmation acknowledgement for the first priority access request; and
assigning, by the processing system, a dedicated spectrum channel for data traffic of the first user device.

16. The method of claim 15, comprising:
receiving, by the processing system, from a second user device, a request to join the selected Wi-Fi network, wherein the request to join comprises a second priority access request corresponding to the EPCS features;
receiving, by the processing system, a confirmation acknowledgement for the second priority access request; and
providing, by the processing system, a higher quality of service to data traffic from the second user device than a best effort service.

17. The method of claim 15, comprising:
receiving, by the processor, from a third user device, a request to join the Wi-Fi network, wherein the request to join comprises a third priority access request corresponding to the EPCS features;
receiving, by the processing system, no confirmation acknowledgement for the third priority access request; and
providing, by the processing system, a best effort quality of service to data traffic of the third user device.

18. The method of claim 16, wherein the first user device and the second user device correspond to public service user equipment for use by government users and the data traffic of the first user device is prioritized over the data traffic of the second user device.

19. The method of claim 15, wherein a special EPCS indicator is attached to the first priority access request.

20. The method of claim 15, wherein the assigning the dedicated spectrum channel further comprises assigning a Wi-Fi frequency spectrum slice for the data traffic of the first user device.
